(19) United States
(12) Patent Application Publication
(10) Pub. No.: US 2026/0189603 A1
(43) Pub. Date: Jul. 2, 2026

(54) USING LIGHTWEIGHT GENERATIVE ARTIFICIAL INTELLIGENCE (AI) MODEL(S) TO PREVENT CYBER-ATTACKS

(71) Applicant: International Business Machines Corporatiion, Armonk, NY (US)

(72) Inventors: Carmen-Gabriela Stefanita, Boston, MA (US); Devan Shah, Vaughan (CA); Aniruddha Redkar, North York (CA); Shant Balolian, Scarborough (CA); Shadman Kaif, Toronto (CA)

(21) Appl. No.: 19/008,493

(22) Filed: Jan. 2, 2025

(51) Int. Cl. H04L 9/40; H04L 41/16

(52) U.S. Cl. CPC H04L 63/1466; H04L 41/16

(57) ABSTRACT

A method, according to one embodiment, includes pre-processing a cyber security attack statement, providing the pre-processed cyber security attack statement to a first lightweight generative artificial intelligence (AI) model, where the first lightweight generative AI model is trained to detect a first type of cyber-attack, and causing a first post-processing data science algorithm to post-process an output of the first lightweight generative AI model. The method further includes generating, based on the post-processing and based on the output of the first lightweight generative AI model, an indication of a cyber-attack. A computer program product, according to another embodiment, includes one or more computer readable storage media, and program instructions stored on the one or more storage media to perform the foregoing method.

### BACKGROUND

The present invention relates to cyber security, and more specifically, this invention relates to cyber-attacks.

A cyber-attack is an action that is designed to target a computer or any element of a computer system. More specifically, the attack aims to change, destroy, or steal data, as well as exploit or harm a network associated with the computer and/or computer system.

There are several different types of cyber-attacks, and the specifics of such attacks are constantly changing in an attempt to overcome cyber security efforts.

### SUMMARY

A method, according to one embodiment, includes pre-processing a cyber security attack statement, providing the pre-processed cyber security attack statement to a first lightweight generative artificial intelligence (AI) model, where the first lightweight generative AI model is trained to detect a first type of cyber-attack, and causing a first post-processing data science algorithm to post-process an output of the first lightweight generative AI model. The method further includes generating, based on the post-processing and based on the output of the first lightweight generative AI model, an indication of a cyber-attack.

A computer program product, according to another embodiment, includes one or more computer readable storage media, and program instructions stored on the one or more storage media to perform the foregoing method.

A computer system, according to another embodiment, includes a processor set, one or more computer readable storage media, and program instructions stored on the one or more storage media to cause the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is a depiction of a logical infrastructure, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for using lightweight generative artificial intelligence (AI) model(s) to prevent cyber-attacks.

In one general embodiment, a method includes pre-processing a cyber security attack statement, providing the pre-processed cyber security attack statement to a first lightweight generative artificial intelligence (AI) model, where the first lightweight generative AI model is trained to detect a first type of cyber-attack, and causing a first post-processing data science algorithm to post-process an output of the first lightweight generative AI model. The method further includes generating, based on the post-processing and based on the output of the first lightweight generative AI model, an indication of a cyber-attack.

In another general embodiment, a computer program product includes one or more computer readable storage media, and program instructions stored on the one or more storage media to perform the foregoing method.

In another general embodiment, a computer system includes a processor set, one or more computer readable storage media, and program instructions stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as cyber security attack statement processing code of block 150 for using lightweight generative artificial intelligence (AI) model(s) to prevent cyber-attacks. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

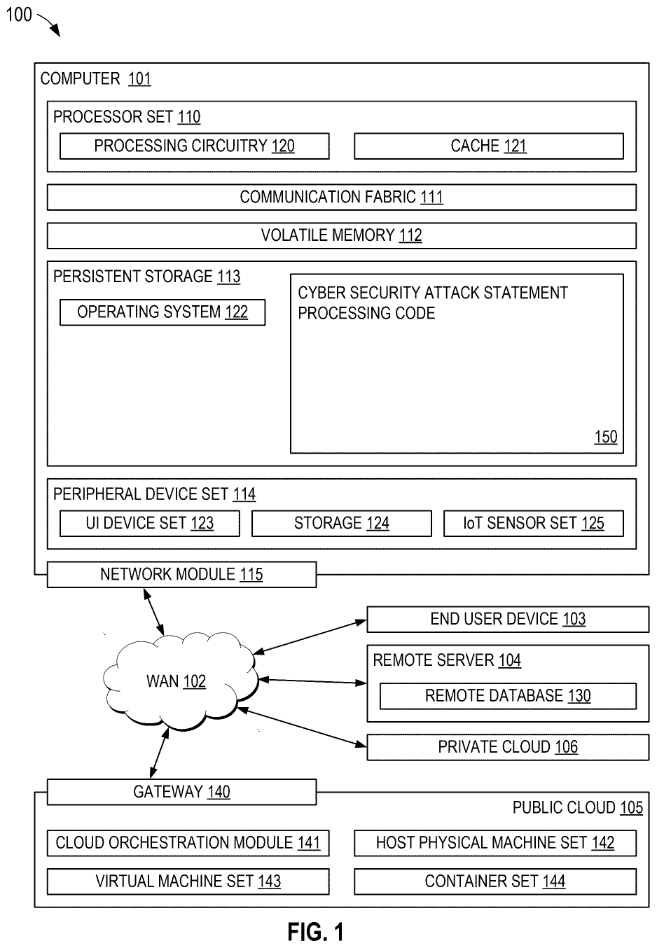

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, a cyber-attack is an action that is designed to target a computer or any element of a computer system. More specifically, the attack aims to change, destroy, or steal data, as well as exploit or harm a network associated with the computer and/or computer system.

There are several different types of cyber-attacks, and the specifics of such attacks are constantly changing in an attempt to overcome cyber security efforts.

In computing, Structured Query Language (SQL) injection is a code injection practice that is sometimes used in order to perform a cyber-attack on a computer system, and more specifically, in order to attack data-driven applications used within a computer system. SQL injection involves malicious SQL statements being inserted into an entry field for execution. When executed, in some cyber-attacks, database constants are obtained by the attacker as a result of the SQL statement being executed.

Security analysts are unable to filter malicious SQL statements from being executed without introducing delay into the computer system, mistakenly removing harmless queries from an execution queue, and failing to filter at least some malicious SQL statements. For example, in some use cases, a cyber security data analyst lacks the resource to document and learn about the best practices to protect software against different cyber security data attacks encompassed in code that could be SQL queries or some other language used to access data. For example, the cyber security data analyst may receive alerts regarding some potential cyber security data attacks on a database and have difficulty understanding the complex SQL queries, as well as the different types of database threats that can compromise the software's security. Accordingly, there is a longstanding unmet need within the technical field of cyber security for a tool that efficiently (without errors, delays and mistakes) protects data assets against ongoingly changing cyber-attacks. Such a solution is described herein and offers artificial intelligence (AI)-based models to create these efficiencies while reducing resolution time within the technical field of cyber security.

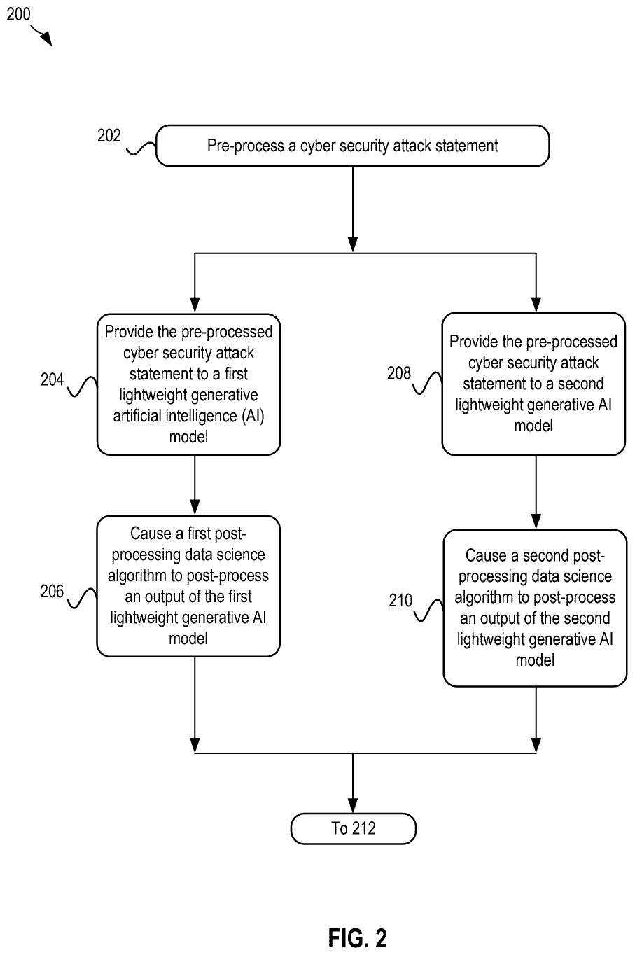

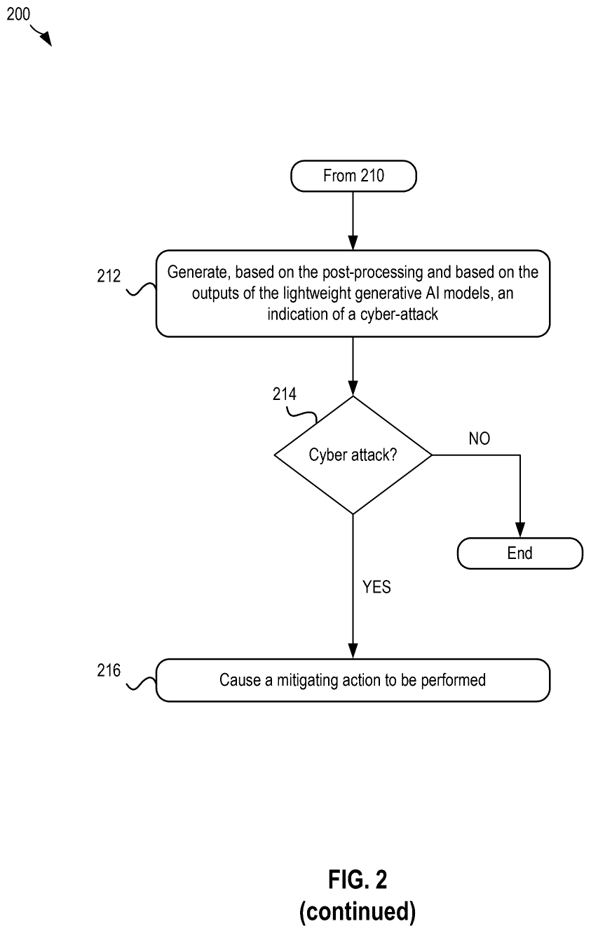

Now referring to FIG. 2, a flowchart of a method 200 is shown according to one embodiment. The method 200 may be performed in accordance with aspects of the present invention in any of the environments depicted in FIGS. 1-3, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that, in some approaches, operations of method 200 may be ongoingly performed in order to identify and mitigate threat events from causing damage to protected assets, e.g., data of a database. In some approaches, one or more of the operations may be event-based operations. For example, in some approaches, at least some operations of method 200 may be performed in response to receiving what may be interpreted as a cyber security attack statement. For context, in some approaches, the cyber security attack statement may be information received in a text entry window, such as a command line. Received cyber security attack statements may be, at least initially, be considered an actual attack statement that is capable of damaging assets until a determination is made that the cyber security attack statement does not have a potential for causing a cyber-attack. In other words, as will now be described below, a vetting process (based on operation(s) of method 200) is performed and/or initiated in response to a determination that a cyber security attack statement has been received.

In some approaches, the cyber security attack statement is a type of query that would become apparent to one of ordinary skill in the art after reading the description herein. In one or more of such approaches, the cyber security attack statement is a query. For example, the cyber security attack statement is, in some approaches, a Structured Query Language (SQL) query, which may be an injection query.

Although an SQL query is mentioned above, the techniques described herein are not limited to being applied to analyze SQL queries. Accordingly, the SQL query is mentioned to provide a general example, while the techniques described herein may be applied with respect to any type of query language or mechanism that is used to interact with data sources databases (e.g., relational, NoSQL, warehouse, big data), SaaS applications (e.g., SLACK, DROPBOX, BOX, ONEDRIVE, etc.), file shares (NAS, network file system (NFS), SHAREPOINT etc.), etc. Moreover, in some approaches, more or less, any data store that holds data can be prone to cyber-attacks, and therefore techniques described herein may, in some approaches, not be specific to SQL based infrastructure. Furthermore, multiple different query languages exist, e.g., such as SQL, MongoDB Query Language, COUCHBASE N1QL, Contextual Query Language (CQL), CYPHER, GREMLIN, HIVEQL, SPARKSQL, PRESTO/TRINO SQL, PL/SQL, T-SQL, Datalog, GraphQL, REST Queries, etc., where this language is used to connect to data sources that hold data.

Furthermore, although an SQL injection is also mentioned above, this injection is merely an example of a cyber-attack that method 200 (and other techniques described herein) may be used to detect and mitigate. However, the overall idea of techniques described herein enable the detection of cyber-attacks, where the cyber-attack may be of a type selected from the group including an injection, an account takeover, an anomaly, a brute force attack, data tampering, and a maliciously stored procedure. Further examples of the cyber-attack include Cross-Site Scripting (XSS), a Denial of Service (DoS), an Insider Threat-Possible Data Leak, Massive Grants, New Grants, operating system (OS) Command Injection, Schema Tampering, SQL Injection (General), SQL Injection-Tautology, SQL Injection-Side Channel, SQL Injection Denial of Service based on a context fed into the lightweight Gen AI model, etc.

Operation 202 includes pre-processing the cyber security attack statement. The cyber security attack statement is, in some approaches, pre-processed by at least one, and preferably a plurality of, pre-processing data science algorithms. The pre-processing data science algorithms may be of a type that would become apparent to one of ordinary skill in the art after reading the descriptions herein.

An attack detector, which in some approaches, is fed and/or processes received queries, may include the one or more data science algorithms that are used to perform operations of method 200. For context, a role of the data science algorithms, in some approaches, includes breaking down tasks to be performed by AI models (see first lightweight generative artificial intelligence (AI) model of operation 204 and second lightweight generative artificial intelligence (AI) model of operation 206). A definition of “breaking down” the tasks, in some approaches, includes filtering out some portions of the query that are not to be considered by such AI model(s) and/or selecting some other portions of the query for the AI model(s) to consider. For example, in one approach, the pre-processing the cyber security attack statement includes causing at least one, and preferably a plurality of pre-processing data science algorithms to convert the SQL query to variables. One or more of the data science algorithms may additionally and/or alternatively instruct one or more of the AI models to pre-process the query into variables, e.g., feed the query into one or more of the AI models with an instruction to pre-process the query into variables and/or to put restrictions on the query formatting. Accordingly, in some approaches, the pre-processing the cyber security attack statement includes causing the plurality of pre-processing data science algorithms to modify formatting of the SQL query. For context, for some approaches in which the cyber security attack statement is a SQL query, the variables may be defined as placeholders used to store data that can be used and manipulated throughout a program. The variables may be of a known type and/or a type that would become apparent to one of ordinary skill in the art after reading the descriptions herein. Furthermore, the formatting and/or restrictions thereof may be of a known type and/or a type that would become apparent to one of ordinary skill in the art after reading the descriptions herein.

The pre-processing the cyber security attack statement may additionally and/or alternatively include causing, e.g., instructing, at least one, and preferably the plurality of pre-processing data science algorithms, to retrieve external resources for the SQL query. For example, at least one of the data science algorithms may, in some approaches, be caused to pull (from a database) a document with some event characteristics. In one or more of such approaches, the data science algorithm may pre-process the document with the event characteristics, and instruct one or more “downstream” AI models that outputs of the data science algorithm are def into to account for the event characteristics.

For context, an AI model being “downstream” of one the pre-processing data science algorithm (as mentioned above) may be based on the principle that the pre-processing data science algorithms described herein, in some preferred approaches, interact with several lightweight generative AI models. More specifically, in one or more of such approaches, the pre-processing data science algorithms may be models or other algorithms designed and thereby configured to perform one or more tasks including, but not limited to, knowing how to execute tasks end to end, iteratively querying the lightweight generative AI models (through application programming interface (API) calls, where one application requests data or services from another), monitoring output, and using other digital tools to accomplish a given goal. Accordingly, the pre-processing preferably modifies the cyber security attack statement into a format ingestible by downstream lightweight generative AI model(s), e.g., a first lightweight generative AI model, a second lightweight generative AI model, etc. In some approaches, different types of pre-processing are performed in parallel by the different pre-processing data science algorithms for an associated one of the lightweight generative AI models, and different resulting versions and/or portions of the modified cyber security attack statement are caused to be fed (in parallel) by the pre-processing data science algorithms into the associated lightweight generative AI models, e.g., see operations 204, 206, 208 and 210.

Associations of pre-processing data science algorithms with the lightweight generative AI models may be based on the types of cyber-attacks that the lightweight generative AI models are configured to identify. In other words, in some deployments of method 200, each lightweight generative AI model is only trained on identifying a certain type of attack (unique from the types of cyber-attacks that the other lightweight generative AI models are trained to identify). Because of this, the pre-processing data science algorithms are preferably, in some approaches, associated with lightweight generative AI models based on the type of pre-processing that the pre-processing data science algorithms perform (e.g., task determination) and/or the type of cyber-attacks that the lightweight generative AI models are configured to identify. This way, in one use case example, a logical pipeline may be used to ensure that outputs of the pre-processing data science algorithms are fed directly into the inputs of associated lightweight generative AI models. For example, operation 204 includes providing the pre-processed cyber security attack statement to a first lightweight generative artificial intelligence (AI) model, where the first lightweight generative AI model is trained to detect a first type of cyber-attack. More specifically, the pre-processed cyber security attack statement may be pre-processed by one of the pre-processing data science algorithms associated with the first lightweight generative AI model. Furthermore, operation 206 includes providing the pre-processed cyber security attack statement to a second lightweight generative AI model, where the second lightweight generative AI model is trained to detect a second type of cyber-attack that is different than the first type of cyber-attack. The pre-processed cyber security attack statement provided to the second lightweight generative AI model by a pre-processing data science algorithm that is associated with the second lightweight generative AI model, where the pre-processing data science algorithm associated with the second lightweight generative AI model is different than the pre-processing data science algorithm associated with the first lightweight generative AI model.

It should be noted that, although two lightweight generative AI models are described to be used in method 200, method 200 may, depending on the approach, be performed with respect to any number of lightweight generative AI models that are each configured to use a pre-processed cyber security attack statement to detect different types of cyber-attacks.

The lightweight generative AI models are, in some approaches, instructed to consume and/or analyze the pre-processed cyber security attack statement(s) to determine whether a cyber-attack is imminent and/or being attempted on a predetermined infrastructure, e.g., an infrastructure on which the cyber security attack statement is received. Accordingly, in some preferred approaches, the lightweight generative AI models are trained to use cyber security attack statements to determine whether a cyber-attack is imminent (predicted with at least a predetermined threshold degree of certainty) and/or being attempted on the predetermined infrastructure. Techniques that would become apparent to one of ordinary skill in the art may be used to train the lightweight generative AI models in such a way. In one or more of such approaches, a training set of data may be used to train, and in some approaches ongoingly refine an accuracy of, the lightweight generative AI models.

In some approaches, only one of the lightweight generative AI models correctly identifies a cyber-attack and provides a response that indicates that the cyber-attack is imminent and/or being attempted. This one of the lightweight generative AI models is able to correctly identify the cyber-attack because the lightweight generative AI model is configured to identify that type of cyber-attack. Meanwhile, the other lightweight generative AI models return a response that indicates that a cyber-attack is imminent and/or being attempted (for the different types of cyber-attacks that the other lightweight generative AI models are configured to detect). For example, the output of the first lightweight generative AI model, in some approaches, identifies the cyber security attack statement as having a potential for causing the first type of cyber-attack, while the output of the second lightweight generative AI model identifies the cyber security attack statement as not having a potential for causing the second type of cyber-attack.

In some preferred approaches, the determination of whether or not the cyber-attack is imminent and/or being attempted is determined using at least one, and preferably a plurality of the lightweight generative AI models, However, the determination of whether or not the cyber-attack is imminent and/or being attempted is preferably not determined using large language model(s) (also referred to herein as “LLMs”). This is because the specialized lightweight generative AI models described herein are able to respond relatively faster compared to LLMs (lightweight generative AI models described herein are able to respond in under one second in some approaches). For this reason, the techniques of embodiments and approaches described herein improve performance of computer systems that are otherwise based on LLMs, by specifically using lightweight generative AI models rather than LLMs for performing determinations in the process of mitigating and preventing cyber-attacks. The lightweight generative AI models described herein thereby enable agile analytics and offer the possibility of real-time detection of a cyber-attack, rather than storing the information in a database and analyzing it later. This efficiency and speed of detection is not otherwise enabled in conventional techniques deployed to detect cyber-attacks, as conventional techniques deployed to detect cyber-attacks all involve the use LLMs. Furthermore, these techniques for identifying a cyber-attack are efficient (seconds or less) to a degree that enable mitigating actions (described elsewhere below) to be performed to prevent the cyber-attack. These efficiencies, and more important the accuracies of AI models, are not otherwise available by use of a human (security analyst) to evaluate queries.

In some approaches, at least one post-processing data science algorithm is used to process (e.g., make sense of) the information output from lightweight generative AI models. This post-processing, in some approaches, include operations that analyze the information in terms of what type of attack was found or not found during the consumption of the pre-processed cyber security attack statement(s) by the lightweight generative AI models.

Operation 208 includes causing a first post-processing data science algorithm to post-process an output of the first lightweight generative AI model. Although, in some approaches, a single post-processing data science algorithm may be used to post-process each of the outputs of the lightweight generative AI model(s), in some other approaches, a plurality of post-processing data science algorithms may be deployed to perform the post-processing. For example, method 200 may include causing a plurality of post-processing data science algorithms, including the first post-processing data science algorithm, to post-process the output of the first lightweight generative AI model. In contrast, in some other approaches, each post-processing data science algorithms of the plurality of post-processing data science algorithms may perform post-processing on an output of an associated one of the lightweight generative AI models. For example, operation 210 method 200 includes causing a second post-processing data science algorithm to post-process an output of the second lightweight generative AI model, e.g., wherein each of the outputs of the models are fed into different data science algorithms.

Operation 212 includes generating, based on the post-processing performed by the first post-processing data science algorithm and based on the output of the first lightweight generative AI model, an indication of a cyber-attack. In some approaches in which more than one lightweight generative AI model generates an output, the indication may be based on more than one of the inputs. For example, the indication of the cyber-attack is, in some approaches, additionally based on the post-processing performed by the second post-processing data science algorithm and based on the output of the second lightweight generative AI model.

For context, the indication, in some approaches, is a report that details the findings with respect to the different types of cyber-attacks. More specifically, such a report may include a confirmation that one or more of the types of cyber-attacks are imminent (in the event that the query is executed and/or fulfilled) and/or being performed. Furthermore, the report may additionally and/or alternatively include a confirmation that one or more of the types of cyber-attacks are not imminent (in the event that the query is executed and/or fulfilled) and/or not being performed. These confirmations may be extracted by the post-processing data science algorithms from the outputs of the lightweight generative AI models.

Mitigating actions may, in some approaches, be performed in response to a determination that one or more of the types of cyber-attacks are imminent and/or being performed. Accordingly, a determination may be made as to whether one or more of the types of cyber-attacks are imminent and/or being performed, e.g., see decision 214. The determination may, in some approaches, be made based on the indication, e.g., whether a “yes” or “no” are present in the indication.

In response to a determination that one or more of the types of cyber-attacks are not imminent and/or not being performed, e.g., as illustrated by the “NO” logical path of decision 214, method 200 optionally ends and/or further analysis on another received cyber security attack statements may be ongoingly performed. In contrast, in response to a determination that one or more of the types of cyber-attacks are imminent and/or being performed, e.g., as illustrated by the “YES” logical path of decision 214, method 200 includes causing a mitigating action to be performed, where the mitigating action is based on a characterization of the cyber-attack in the indication of the cyber-attack, e.g., see operation 216. For context, the characterization of the cyber-attack in the indication of the cyber-attack includes a specification of the type of the cyber-attack that is provided in an output of the lightweight generative AI model that determines that the cyber-attack is imminent and/or being performed.

In some approaches in which the cyber security attack statement is a query, the mitigating action may be selected from the group of mitigating actions including blocking access to a database requested in the query, blocking and reporting a device from which the query is received, inspecting other actions taken by and/or queries received from the device from which the query is received. Other mitigating actions include blocking and/or quarantining a user profile of the device from which the query is received, adding the indication and information associated therewith of the cyber-attack to a training dataset (which may be used to train additional lightweight generative AI models that are thereafter deployed to analyze another query), etc. In preferred approaches, the indication of the cyber-attack and the mitigating action are not determined using large language model(s).

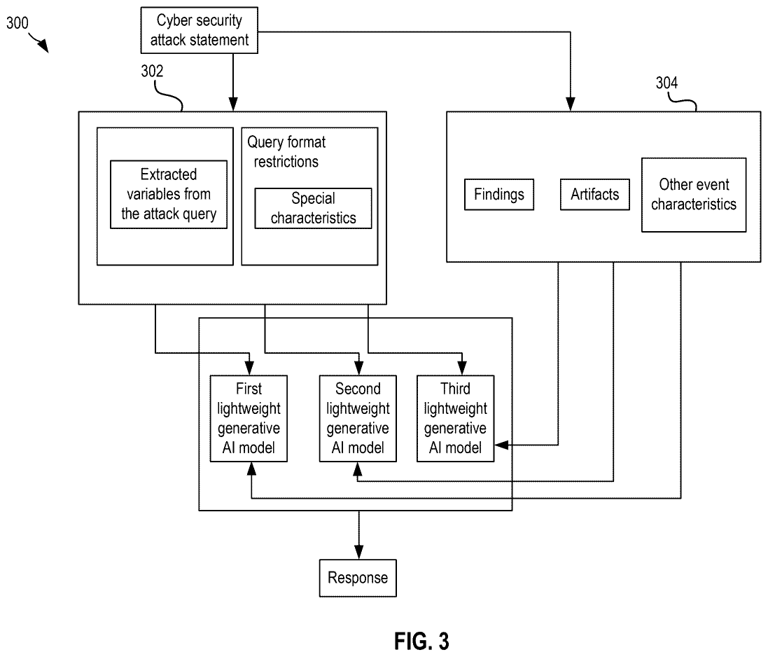

FIG. 3 depicts a logical infrastructure 300, in accordance with one embodiment. As an option, the present logical infrastructure 300 may be implemented in conjunction with features from any other embodiment listed herein, such as those described with reference to the other FIGS. Of course, however, such logical infrastructure 300 and others presented herein may be used in various applications and/or in permutations which may or may not be specifically described in the illustrative embodiments listed herein. Further, the logical infrastructure 300 presented herein may be used in any desired environment.

The logical infrastructure 300 may be controlled for enabling a detection system for cybersecurity data threats in near-real time powered by lightweight generative AI models. Lightweight generative AI models, e.g., such as Small Language Models (SLM), are a subset of natural language processing (NLP) models designed to perform various language-related tasks but with significantly fewer parameters compared to larger and more heavy-duty generative AI models such as LLMs. The label “lightweight” in this context refers to one or more of, the size of the model's neural network, the number of parameters, and the volume of data the model is further trained on, such as instruction specific data. Due to their relatively smaller size, lightweight generative AI models require less computational power and memory than other models.

The logical infrastructure 300 includes lightweight generative AI models, e.g., see first lightweight generative AI model, second lightweight generative AI model, and third lightweight generative AI model. Furthermore, the logical infrastructure 300 includes a series of data science algorithms that instruct the lightweight generative AI models to contextually detect data attack types and to bridge the gap in technical experience. For example, a plurality of pre-processing data science algorithms of a first module 302 may be used to perform pre-processing techniques. These pre-processing techniques may, in some approaches, include performing parameterization operations on the cyber security attack statement (which may be a query) to extract variables from the attack cyber security attack statement, e.g., see Extracted variables from the attack query. These operations may additionally and/or alternatively include applying query format restrictions on the attack cyber security attack statement, e.g., see Query format restrictions, to determine special characteristics of the attack cyber security attack statement. Other pre-processing data science algorithms of a second module 304 may be used to perform pre-processing techniques to extract other information from the attack cyber security attack statement, e.g., see findings, artifacts and other event characteristics, which may be query information of a type that would become apparent to one of ordinary skill in the art after reading the descriptions herein.

In some approaches, the pre-processing data science algorithms autonomously pre-process the attack cyber security attack statement and contextualize any predetermined types of related cyber security attack event characteristics. These characteristics are then transformed into tasks to be performed by lightweight generative AI models.

Results of the pre-processing are used by transformer-based models (identified as lightweight generative AI models) to detect potential cyber security data attacks, and more specifically, to detect what kind of attack the statement poses. In some approaches, the lightweight generative AI models are instructed by the pre-processing data science algorithms which give instructions or tasks to the models. For context, in some approaches, the pre-processing data science algorithms may be models or other types of algorithms that can carry out complex, multistep goals and can transmit those tasks to one or more of the lightweight generative AI models or a pipeline of lightweight generative AI models for further execution.

Data threats can occur in different varieties. Accordingly, each of the lightweight generative AI models may be used as unique detectors for different contexts. In other words, in some approaches, each of the lightweight generative AI models may be trained to detect different types of cyber-attack threats. In one or more of such approaches, the pre-processing data science algorithms may provide different portions of the pre-processed the attack cyber security attack statement (concurrently in a logical pipeline).

An output of one or more of the lightweight generative AI models identifies a specific type of cyber security attack from context of the attack cyber security attack statement and/or event characteristics presented in the pre-processed the attack cyber security attack statement (without having the attack specifically named anywhere in the pre-processed the attack cyber security attack statement). Based on these output(s), a mitigating action may be performed to mitigate the cyber-attack, e.g., see response.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
pre-processing a cyber security attack statement;
providing the pre-processed cyber security attack statement to a first lightweight generative artificial intelligence (AI) model, wherein the first lightweight generative AI model is trained to detect a first type of cyber-attack;
causing a first post-processing data science algorithm to post-process an output of the first lightweight generative AI model; and
generating, based on the post-processing and based on the output of the first lightweight generative AI model, an indication of a cyber-attack.

2. The method of claim 1, wherein the cyber security attack statement is a query.

3. The method of claim 2, further comprising:
causing a plurality of post-processing data science algorithms, including the first post-processing data science algorithm, to post-process the output of the first lightweight generative AI model,
wherein the pre-processing the cyber security attack statement includes:
causing a plurality of pre-processing data science algorithms to convert the query to variables;
causing the plurality of pre-processing data science algorithms to modify formatting of the query; and
causing the plurality of pre-processing data science algorithms to retrieve external resources for the query.

4. The method of claim 1,
wherein the pre-processed cyber security attack statement is provided to a second lightweight generative AI model, wherein the second lightweight generative AI model is trained to detect a second type of cyber-attack that is different than the first type of cyber-attack, and further comprising:
causing a second post-processing data science algorithm to post-process an output of the second lightweight generative AI model,
wherein the indication of the cyber-attack is based on the post-processing and based on the output of the second lightweight generative AI model.

5. The method of claim 4, wherein the output of the first lightweight generative AI model identifies the cyber security attack statement as having a potential for causing the first type of cyber-attack, wherein the output of the second lightweight generative AI model identifies the cyber security attack statement as not having a potential for causing the second type of cyber-attack.

6. The method of claim 4, wherein the pre-processing modifies the cyber security attack statement into a format ingestible by the first lightweight generative AI model and the second lightweight generative AI model.

7. The method of claim 1, wherein the cyber security attack statement is a query, and
further comprising:
causing a mitigating action to be performed, wherein the mitigating action is based on a characterization of the cyber-attack in the indication of the cyber-attack,
wherein the mitigating action is selected from the group consisting of: blocking access to a database requested in the query, blocking and reporting a device from which the query is received, blocking or quarantining a user profile of the device from which the query is received, and adding the indication of the cyber-attack to a training dataset.

8. The method of claim 7, wherein the indication of the cyber-attack and the mitigating action are not determined using large language model(s).

9. The method of claim 1, wherein the cyber-attack is of a type selected from the group consisting of: an injection, an account takeover, an anomaly, a brute force attack, data tampering, and a maliciously stored procedure.

10. A computer program product comprising:
one or more computer readable storage media; and
program instructions stored on the one or more storage media to perform operations comprising:
pre-processing a cyber security attack statement;
providing the pre-processed cyber security attack statement to a first lightweight generative artificial intelligence (AI) model, wherein the first lightweight generative AI model is trained to detect a first type of cyber-attack;
causing a first post-processing data science algorithm to post-process an output of the first lightweight generative AI model; and
generating, based on the post-processing and based on the output of the first lightweight generative AI model, an indication of a cyber-attack.

11. The computer program product of claim 10, wherein the cyber security attack statement is a query.

12. The computer program product of claim 11, wherein the operations further comprise:
causing a plurality of post-processing data science algorithms, including the first post-processing data science algorithm, to post-process the output of the first lightweight generative AI model,
wherein the pre-processing the cyber security attack statement includes:
causing a plurality of pre-processing data science algorithms to convert the query to variables;
causing the plurality of pre-processing data science algorithms to modify formatting of the query; and
causing the plurality of pre-processing data science algorithms to retrieve external resources for the query.

13. The computer program product of claim 10,
wherein the pre-processed cyber security attack statement is provided to a second lightweight generative AI model, wherein the second lightweight generative AI model is trained to detect a second type of cyber-attack that is different than the first type of cyber-attack, wherein the operations further comprise:
causing a second post-processing data science algorithm to post-process an output of the second lightweight generative AI model,
wherein the indication of the cyber-attack is based on the post-processing and based on the output of the second lightweight generative AI model.

14. The computer program product of claim 13, wherein the output of the first lightweight generative AI model identifies the cyber security attack statement as having a potential for causing the first type of cyber-attack, wherein the output of the second lightweight generative AI model identifies the cyber security attack statement as not having a potential for causing the second type of cyber-attack.

15. The computer program product of claim 13, wherein the pre-processing modifies the cyber security attack statement into a format ingestible by the first lightweight generative AI model and the second lightweight generative AI model.

16. The computer program product of claim 10, wherein the cyber security attack
statement is a query, wherein the operations further comprise:
causing a mitigating action to be performed, wherein the mitigating action is based on a characterization of the cyber-attack in the indication of the cyber-attack,
wherein the mitigating action is selected from the group consisting of: blocking access to a database requested in the query, blocking and reporting a device from which the query is received, blocking or quarantining a user profile of the device from which the query is received, and adding the indication of the cyber-attack to a training dataset.

17. The computer program product of claim 16, wherein the indication of the cyber-attack and the mitigating action are not determined using large language model(s).

18. The computer program product of claim 10, wherein the cyber-attack is of a type selected from the group consisting of: an injection, an account takeover, an anomaly, a brute force attack, data tampering, and a maliciously stored procedure.

19. A computer system comprising:
a processor set;
one or more computer readable storage media; and
program instructions stored on the one or more storage media to cause the processor set to perform operations comprising:
pre-processing a cyber security attack statement;
providing the pre-processed cyber security attack statement to a first lightweight generative artificial intelligence (AI) model, wherein the first lightweight generative AI model is trained to detect a first type of cyber-attack;
causing a first post-processing data science algorithm to post-process an output of the first lightweight generative AI model; and
generating, based on the post-processing and based on the output of the first lightweight generative AI model, an indication of a cyber-attack.

20. The computer system of claim 19, wherein the cyber security attack statement is a query.
